(19) United States
(12) Patent Application Publication
(10) Pub. No.: US 2015/0109333 A1
(43) Pub. Date: Apr. 23, 2015

(54) PROJECTING DEVICE AND PROJECTION IMAGE PROCESSING METHOD THEREOF

(71) Applicant: Lite-On IT Corporation, Taipei (TW)

(72) Inventors: Wen-Long LIN, Taipei (TW); Kevin KW CHENG, Taipei (TW); Chiou-Ming WU, Taipei (TW); YU-TE LIAO, Taipei (TW)

(73) Assignee: Lite-On IT Corporation, Taipei (TW)

(21) Appl. No.: 14/199,955

(22) Filed: Mar. 6, 2014

(30) Foreign Application Priority Data
Oct. 22, 2013 (CN) 201310499521.1

(51) Int. Cl. G06T 5/00; G06T 3/00

(52) U.S. Cl. CPC G06T 5/006; G06T 3/0068; G06T 5/003; G06T 2207/20216; G06T 2207/20201
USPC 345/631; 345/682

(57) ABSTRACT

The present invention provides a projecting device including a movement detecting unit, an image processing unit, and a projection module. The movement detecting unit is configured to detect displacement information of the projecting device. The image processing unit is configured to receive an image data frame, adjust a position of the image data frame related to a virtual image frame according to the displacement information, and generate a projection frame according to the intersection between the image data frame and the virtual image frame. The projection module is configured to project the projection frame on a projection plane.

### CROSS REFERENCE TO RELATED APPLICATIONS

This Application claims priority of China Patent Application No. 201310499521.1, filed on Oct. 22, 2013, the entirety of which is incorporated by reference herein.

### BACKGROUND OF THE INVENTION

1. Field of the Invention

The invention relates to projecting devices, and more particularly to projecting devices having an image stabilization function.

2. Description of the Related Art

Nowadays, projecting devices are used as display devices for electronic devices such as computers to output frames. A conventional projecting device is usually fixed or placed on a stable surface, and may not be moved or vibrated. Therefore, the position of the image projected onto a projection plane by the projecting device can be fixed.

Due to improvements in the techniques employed by projecting devices, the size of projecting devices has become smaller, and their weight has become lighter, such that a projecting device can be installed in a hand-held device. When a user holds the projecting device in his hands, the projected image is usually unstable because of slight hand movements and/or vibrations. Therefore, the issue of how to solve the problem of unclear images caused by shaking is an important one.

### BRIEF SUMMARY OF THE INVENTION

In an embodiment of the present invention, a projecting device comprises a movement detection unit configured to detect displacement information of the projecting device, an image processing unit configured to receive an image data frame, modify a position of the image data frame related to a virtual image frame according to the displacement information, and generate a projection frame according to an overlap between the image data frame and the virtual image frame, and a projection module configured to project the projection frame on a projection plane.

The present invention further provides a projected image processing method for a projecting device. The projection image processing method comprising: detecting displacement information of the projecting device; modifying a position of the image data frame related to a virtual image frame according to the displacement information; generating a projection frame according to an overlap between the image data frame and the virtual image frame; and projecting the projection frame on a projection plane.

### BRIEF DESCRIPTION OF DRAWINGS

The invention will become more fully understood by referring to the following detailed description with reference to the accompanying drawings, wherein:

FIG. 1 is a schematic diagram illustrating an embodiment of the projecting device according to the invention.

FIG. 2 is a schematic diagram illustrating a projection frame is projected to a projection plane by a conventional projecting device.

FIG. 3A is a schematic diagram illustrating an embodiment of the projecting device projecting the projection frame to the projection plane in a normal state.

FIG. 3B is a schematic diagram showing the projection frame of FIG. 3A.

FIG. 4A is a schematic diagram illustrating an embodiment of the projecting device projecting the projection frame to the projection plane, when the projecting device is shifted.

FIG. 4B is a schematic diagram showing the projection frame of FIG. 4A.

FIG. 5A is a schematic diagram illustrating the other embodiment of the projecting device projecting the projection frame to the projection plane in a normal state.

FIG. 5B is a schematic diagram showing the projection frame of FIG. 5A.

FIG. 6A is a schematic diagram illustrating the other embodiment of the projecting device projecting the projection frame to the projection plane, when the projecting device is shifted.

FIG. 6B is a schematic diagram showing the projection frame of FIG. 6A.

FIG. 7 is a flowchart of an embodiment of a control method for the projecting device according to the invention.

FIG. 8A is a flowchart of an embodiment of a method for generating a modified projection frame according to the invention

FIG. 8B is a flowchart of the other embodiment of a method for generating a modified projection frame according to the invention.

### DETAILED DESCRIPTION OF THE INVENTION

Embodiments, or examples, illustrated in the drawing are now disclosed using specific language. It will nevertheless be understood that the embodiments and examples are not intended to be limiting. Any alterations and modifications in the disclosed embodiments, and any further applications of the principles disclosed in this document are contemplated as that which would normally occur to one of ordinary skill in the pertinent art. Reference numbers may be repeated throughout the embodiments, but they do not require that feature(s) of one embodiment apply to another embodiment, even if they share the same reference number.

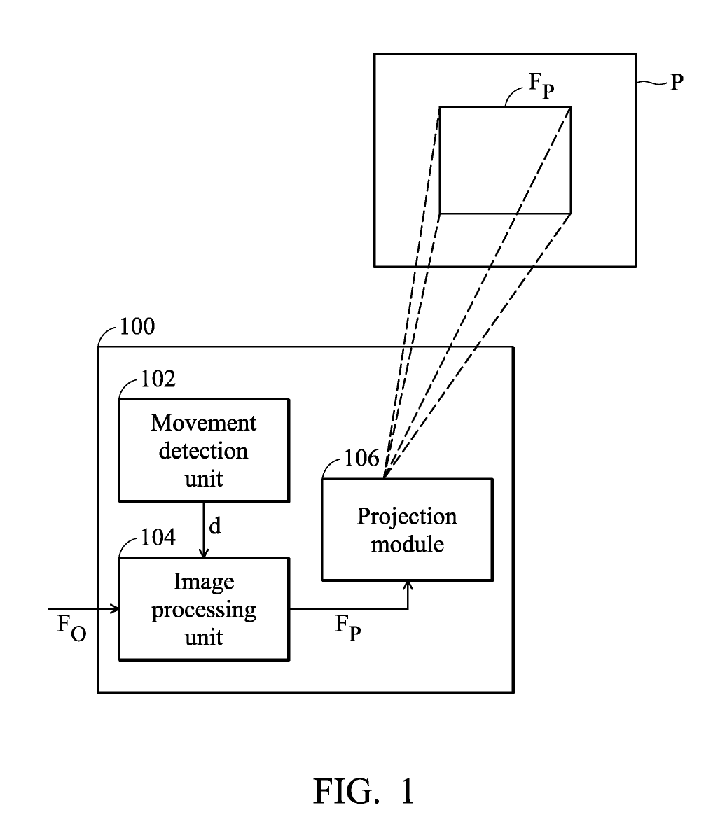

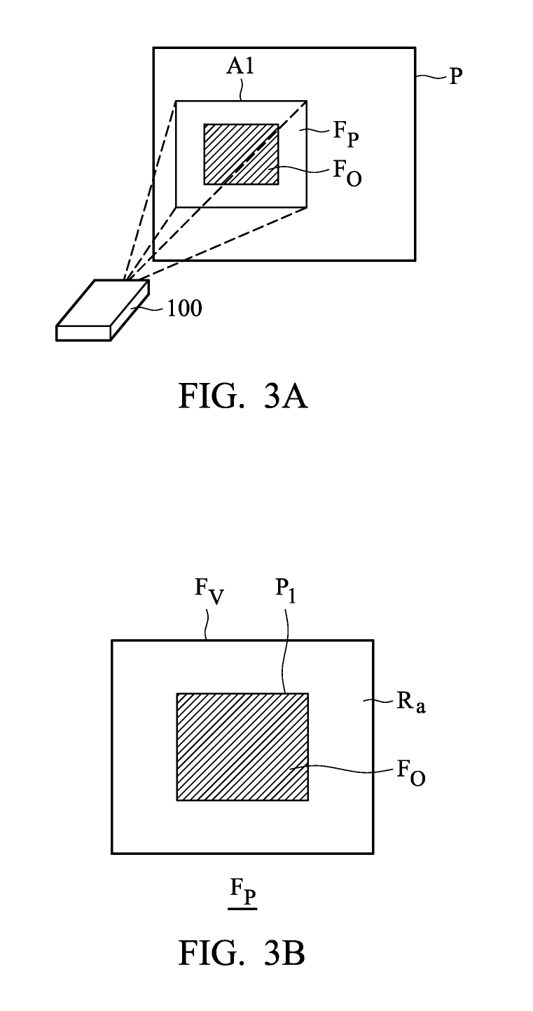

FIG. 1 is a schematic diagram illustrating an embodiment of the projecting device according to the invention. The projecting device 100 comprises a movement detection unit 102, an image processing unit 104 and a projection module 106. The movement detection unit 102, such as G sensor, is configured to detect displacement information d of the projecting device itself, and provides the displacement information d to the image processing unit 104. The image processing unit 104 is configured to receive an image data frame Fo, modify a position of the image data frame Fo related to a virtual image frame Fv (as shown in FIG. 3B) according to the displacement information d, generate a projection frame Fp accordingly, and transmits the projection frame Fp to the projection module 106. In the embodiment, the image data frame Fo may be received from an output signal of an external electronic device or a storage unit (not shown) of the projecting device 100. The projection module 106 is configured to project the projection frame Fp on a projection plane P.

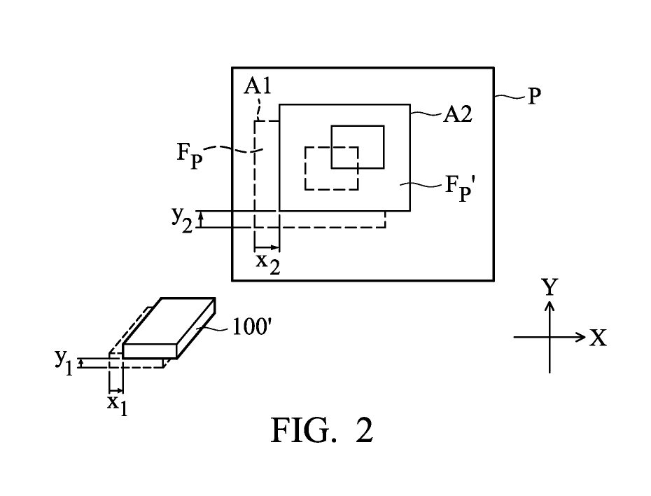

Generally speaking, if there is no modification, the movement of the projecting device 100 causes the projection frame Fp on a projection plane P move, as shown in FIG. 2. FIG. 2 is a schematic diagram illustrating a projection frame Fp is projected to a projection plane P by a conventional projecting device. When the conventional projecting device 100′ is shifted a displacement x1 and a displacement y1 because of shaking, a display position of the projection frame Fp moves from a display area A1 to a display area A2. Because the image content of the projection frame Fp′ projected to the display area A2 and the image content of the projection frame Fp projected to the display area A1 are the same, a viewer may observe the vibration of the projected image. Therefore, if the conventional projecting device 100′ is installed on an unstable take or hold by hand, the image on the projection plane P may sway accordingly, so that the viewer is difficult to observe a clear image.

In order to solve to above-mentioned problems, in an embodiment of the invention, when the projecting device 100 is shifted by vibration, the image processing unit 104 modifies the projection frame to make the projected image stable. The movement detection unit 102 provides the detected displacement information d to the image processing unit 104. The image processing unit 104 modifies a position of the image data frame Fo related to a virtual image frame Fv (as shown in FIG. 3B) according to the displacement information d, and generates a modified projection frame Fp′ according to the overlapping between the image data frame Fo and the virtual image frame Fv, in order to compensate the displacement of projection position resulted from vibration of the projecting device 100. Therefore, when the projection module 106 projects the projection frame Fp on a projection plane P, a position of the image data frame Fo can be projected at the same position of the projection plane P.

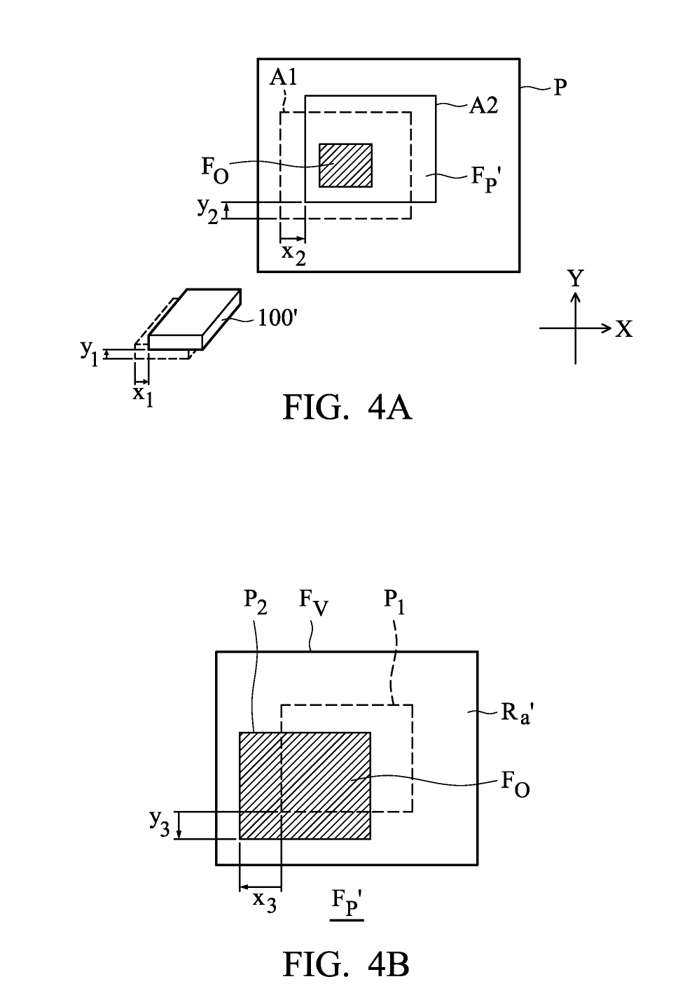

The operations of the projecting device 100 based on an embodiment of the invention are discussed in detail below, and with reference to FIGS. 3A-4B. FIG. 3A is a schematic diagram illustrating an embodiment of the projecting device 100 projecting the projection frame Fp to the projection plane P in a normal state. FIG. 3B is a schematic diagram showing the projection frame Fp of FIG. 3A. As shown in FIG. 3A, when the projecting device 100 is in the normal state, namely the projecting device 100 is not shaken or shifted, the projection module 106 will project the projection frame Fp onto the display area A1 of the projection plane P. The image shown on the display area A1 is the image of the projection frame Fp, and the projection frame Fp includes the image of the image data frame Fo.

As shown in FIG. 3B, the projection frame Fp is defined according to a virtual image frame Fv. The virtual image frame Fv is an available projection area for the projecting device 100, the size of the virtual image frame Fv may be larger than or equal to the image data frame Fo. In other words, a size of the available projection area for the projecting device 100 can be set to be larger or equal to the image data frame Fo. In the embodiment, the size of the virtual image frame Fv is larger than the image data frame Fo for example. In the embodiment of the present invention, the projection frame Fp is formed by the image data frame Fo and a redundant image area Ra. The redundant image area Ra is the area inside the virtual image frame Fv and without overlapping the image data frame Fo. In other words, the area inside the virtual image frame Fv except the area of the image data frame Fo is the redundant image area Ra.

In an embodiment of the present invention, the image processing unit 104 may set the image in the redundant image area Ra to a particular image. For example, if the image processing unit 104 set the redundant image area Ra to a monochrome image (ex, a black image), the projection frame Fp projected to the projection plane P will include the image data frame Fo and the black image related to the redundant image area Ra. In the other embodiments, the particular image can be a picture image. In addition, the image of the redundant image area Ra may be not shown in the other embodiment of the present invention. For example, if the image processing unit 104 is set to not display the redundant image area Ra, the projection module 106 turns off the projection light corresponds to the redundant image area Ra.

Next, please refer to FIGS. 4A and 4B. FIG. 4A is a schematic diagram illustrating an embodiment of the projecting device 100 projecting the projection frame Fp to the projection plane P, when the projecting device 100 is shifted. FIG. 4B is a schematic diagram showing the projection frame Fp of FIG. 4A. When the projecting device 100 is shaken and shifted a displacement of x1 in +X direction and a displacement of y1 in +Y direction, the movement detecting unit 102 can detect corresponding displacement information d, and the movement detecting unit 102 provides the displacement information d to the image processing unit 104. The image processing unit 104 modifies a position of the image data frame Fo related to a virtual image frame Fv according to the displacement information d. As shown in FIG. 4B, it assumes that the image data frame Fo is located at an original position P1 of the virtual image frame Fv before modification. When the projecting device 100 is shifted along +X direction and +Y direction, the image processing unit 104 shifts the image data frame Fo related to the virtual image frame Fv along the opposite direction of the displacement information d, namely −X direction and −Y direction. Therefore, the image processing unit 104 shifts the image data frame Fo from the original position P1 to the modified position P2 along a displacement of x3 in −X direction and a displacement of y3 in −Y direction, as shown in FIG. 4B.

After the image processing unit 104 shifts the image data frame Fo to the modified position P2, the area inside the virtual image frame Fv and without overlapping the image data frame Fo represents a modified redundant image area Ra′. The image processing unit 104 generates a modified projection frame Fp′ by combining the particular image of the modified redundant image area Ra′ with the image data frame Fo. Next, the modified projection frame Fp′ is projected onto the projection plane P by the projection module 106, as shown in FIG. 4A. The modified projection frame Fp′ on the projection plane P is shifted from the display area A1 to the display area A2 along a displacement of x2 in +X direction and a displacement of y2 in +Y direction, because the projecting device 100 is shaken. Nevertheless, the image data frame Fo is still projected on the same position of the projection plane P, because the position of the image data frame Fo in the modified projection frame Fp′ has been modified. In the embodiment of the invention, the displacements x1, y1, x2, y2, x3, y3 respectively indicate a movement direction of the projecting device, a movement direction of the image data frame Fp′ on the projection plane P, the movement direction of the image data frame Fo related to a virtual image frame Fv. However, the actual distance of the displacement is not limited, a skilled in the art can calculate the corresponding distance according to the actual application, and there is no further description.

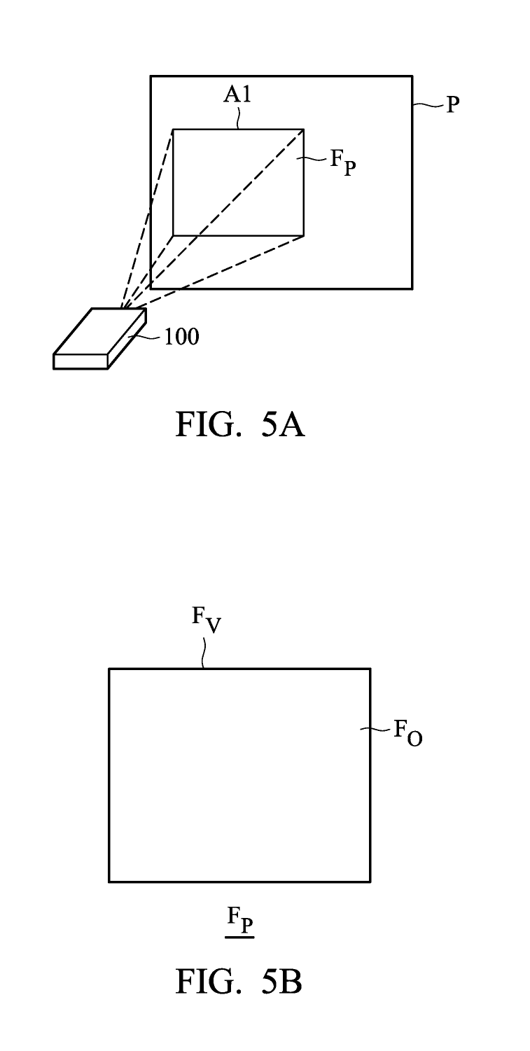

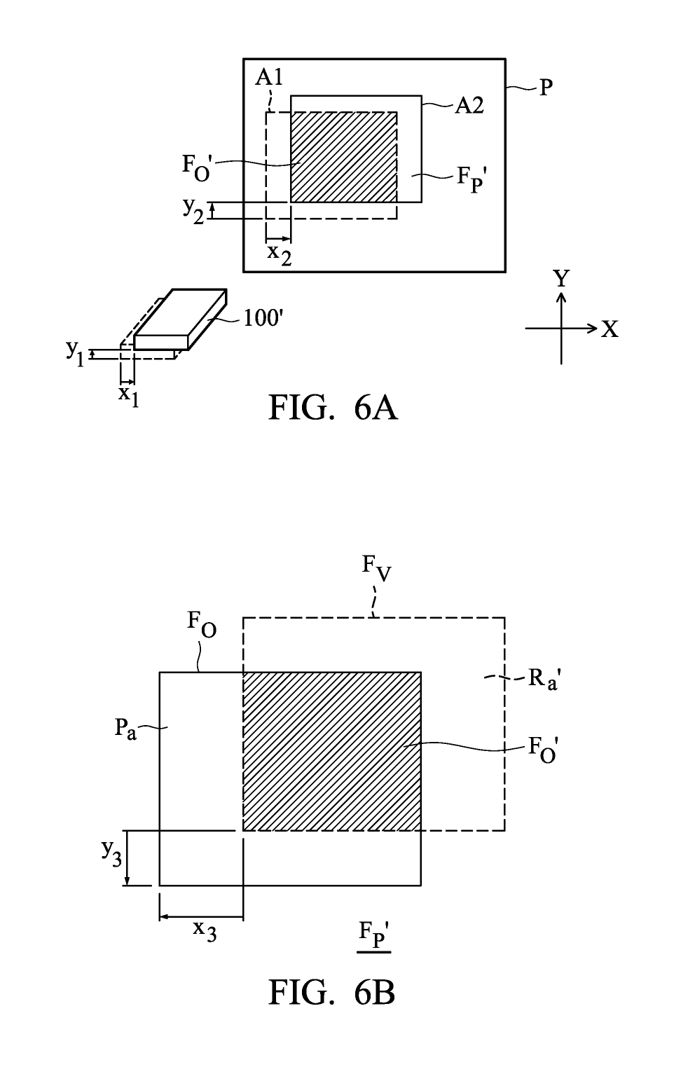

The operations of the projecting device 100 based on the other embodiment of the invention are discussed in detail below, and with reference to FIGS. 5A-6B. FIG. 5A is a schematic diagram illustrating the other embodiment of the projecting device 100 projecting the projection frame Fp to the projection plane P in a normal state. FIG. 5B is a schematic diagram showing the projection frame Fp of FIG. 5A. In the embodiment, the size of the virtual image frame Fv is equal to the image data frame Fo. In other words, the size of the available projection area for the projecting device 100 is equal to the size of the image data frame Fo.

As shown in FIG. 5A, when the projecting device 100 is in the normal state, namely the projecting device 100 is not shaken or shifted, the projection module 106 will project the projection frame Fp onto the display area A1 of the projection plane P. The image shown on the display area A1 is the image of the projection frame Fp, and the projection frame Fp includes the image of the image data frame Fo. In the embodiment, because the size of the virtual image frame Fv is equal to the image data frame Fo, the image data frame Fo matches with the virtual image frame Fv when the projecting device is not shaken or shifted. In other words, the image data frame Fo coincides with the virtual image frame Fv, and there is no redundant image area Ra. As shown in FIG. 5B, when the image data frame Fo coincides with the virtual image frame Fv, the image of the projection frame Fp is equivalent to the image data frame Fo.

Next, please refer to FIGS. 6A and 6B. FIG. 6A is a schematic diagram illustrating the other embodiment of the projecting device projecting the projection frame Fp to the projection plane P, when the projecting device is shifted. FIG. 6B is a schematic diagram showing the projection frame Fp of FIG. 6A. When the projecting device 100 is shaken and shifted a displacement of x1 in +X direction and a displacement of y1 in +Y direction, the movement detecting unit 102 can detect corresponding displacement information d, and the movement detecting unit 102 provides the displacement information d to the image processing unit 104. The image processing unit 104 modifies a position of the image data frame Fo related to a virtual image frame Fv according to the displacement information d. As shown in FIG. 6B, it assumes that the image data frame Fo coincides with the virtual image frame Fv before modification. When the projecting device 100 is shifted along +X direction and +Y direction, the image processing unit 104 shifts the image data frame Fo related to the virtual image frame Fv along the opposite direction of the displacement information d, namely −X direction and −Y direction. Therefore, the image processing unit 104 shifts the image data frame Fo along a displacement of x3 in −X direction and a displacement of y3 in −Y direction, as shown in FIG. 6B.

After the image processing unit 104 shifts the image data frame Fo, the area inside the virtual image frame Fv and without overlapping the image data frame Fo is defined as a modified redundant image area Ra′. In the embodiment, because the size of the virtual image frame Fv is equal to the image data frame Fo, the area inside the image data frame Fo and without overlapping the virtual image frame Fv is defined as a cut image area Pa after the image processing unit 104 shifts. In other words, the cut image area Pa is the area inside the image data frame Fo but outside the area of the virtual image frame Fv, and the cut image area Pa will not be projected to the projection plane P. On the other hand, the area inside the image data frame Fo and overlapping the virtual image frame Fv is defined as a modified image data frame Fo′ after the image processing unit 104 shifts, and the modified image data frame Fo′ remains to be projected to the projection plane P.

The image processing unit 104 generates a modified projection frame Fp′ by combining the particular image of the modified redundant image area Ra′ with the modified image data frame Fo′. Next, the modified projection frame Fp′ is projected onto the projection plane P by the projection module 106, as shown in FIG. 6A. The modified projection frame Fp′ on the projection plane P is shifted from the display area A1 to the display area A2, because the projecting device 100 is shaken. Nevertheless, the image data frame Fo′ is still projected on the same position of the projection plane P, because the position of the image data frame Fo′ in the modified projection frame Fp′ has been modified.

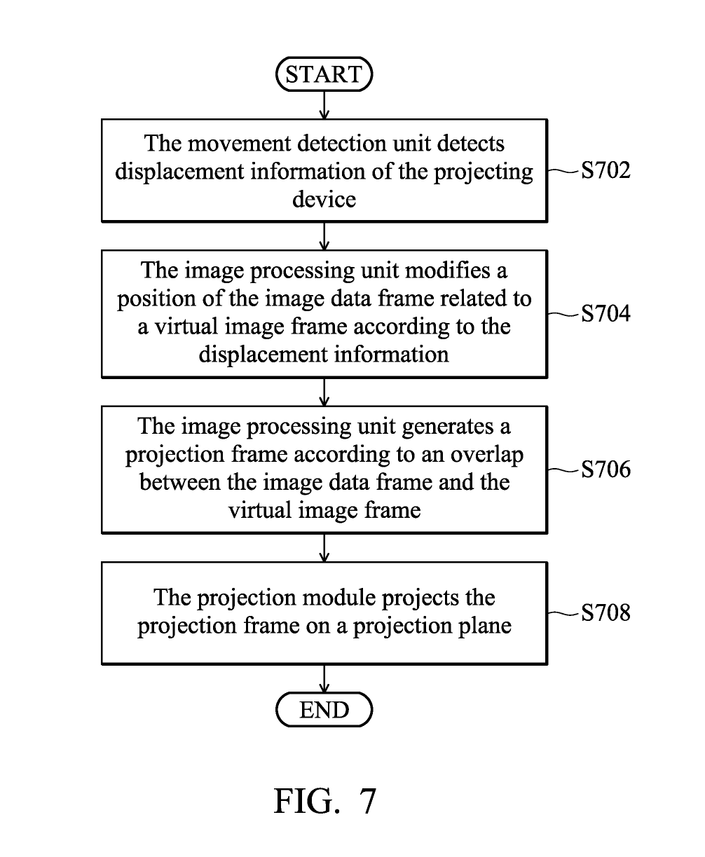

FIG. 7 is a flowchart of an embodiment of a control method for the projecting device according to the invention. In step S702, the movement detection unit 102 detects displacement information d of the projecting device 100. If the movement of the projecting device 100 is detected, in step S704, the image processing unit 104 modifies a position of the image data frame Fo related to a virtual image frame Fv according to the displacement information d. In step S706, the image processing unit 104 generates a projection frame Fp′ according to an overlap between the image data frame Fo and the virtual image frame Fv, and transmits the projection frame Fp′ to the projection module 106. Next, in step S708, the projection module 106 projects the projection frame Fp′ on a projection plane P.

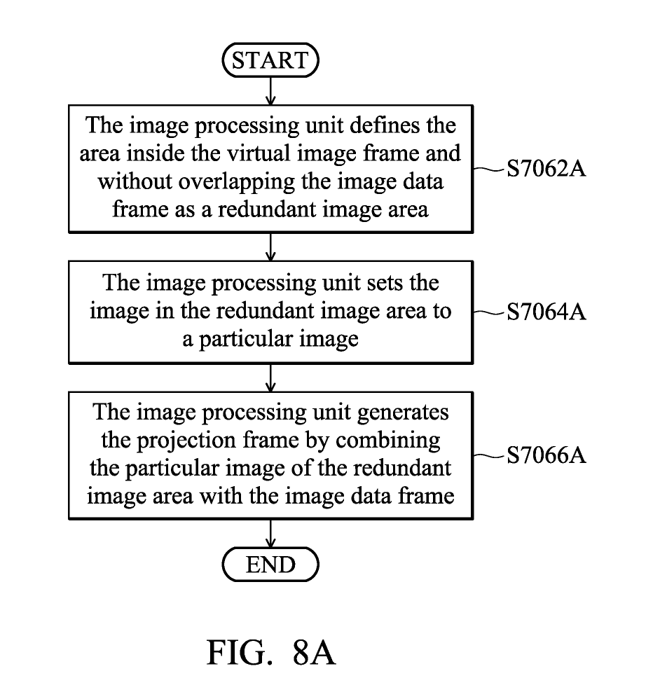

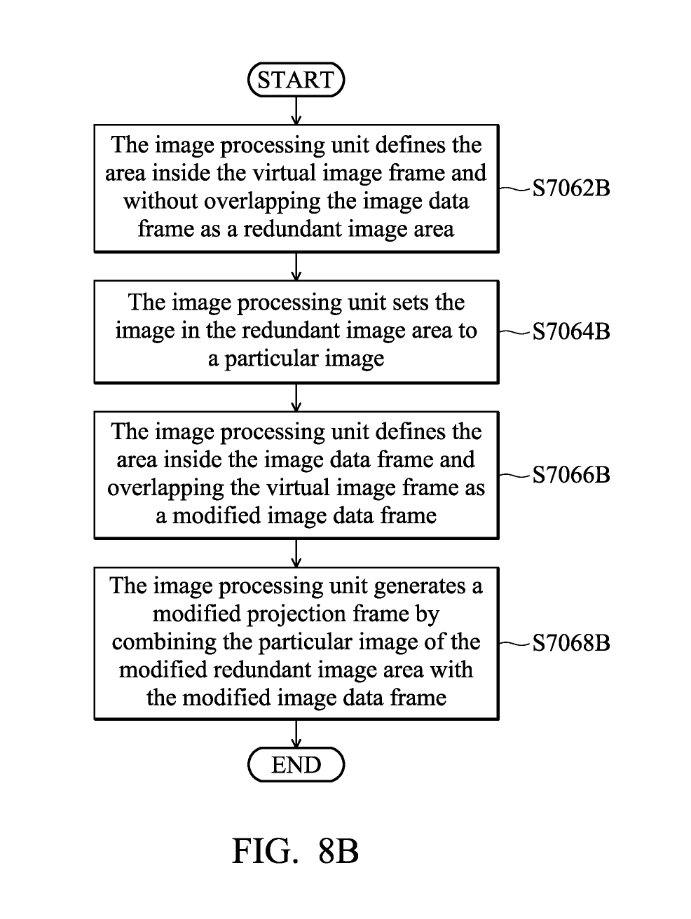

FIG. 8A is a flowchart of an embodiment of a method for generating a modified projection frame according to the invention. In an embodiment, the step S706 of FIG. 7 may further comprise the following steps. In step S7062A, the image processing unit 104 defines the area inside the virtual image frame Fv and without overlapping the image data frame Fo as a redundant image area Ra. In step S7064A, the image processing unit 104 sets the image in the redundant image area Ra to a particular image. In step S7066A, the image processing unit 104 generates the projection frame Fp′ by combining the particular image of the redundant image area Ra with the image data frame Fo.

FIG. 8B is a flowchart of the other embodiment of a method for generating a modified projection frame according to the invention. In the other embodiment, the step S706 of FIG. 7 may further comprise the following steps. In step S7062B, the image processing unit 104 defines the area inside the virtual image frame Fv and without overlapping the image data frame Fo as a redundant image area Ra. In step S7064B, the image processing unit 104 sets the image in the redundant image area Ra to a particular image. In step S7066B, the image processing unit 104 defines the area inside the image data frame Fo and overlapping the virtual image frame Fv as a modified image data frame Fo′. In step S7068B, the image processing unit 104 generates a modified projection frame Fp′ by combining the particular image of the modified redundant image area Ra′ with the modified image data frame Fo′.

According to the projecting device and the projection image processing method, it can detect movement information of the projecting device, and modify a position of the image data frame by image processing to generate a modified projection frame, in order to project the image data frame onto the same position of a projection plane. Therefore, display for the image data frame will not be affected by the projecting device shaking, and the viewing quality of the projection screen is improved.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A projecting device, comprising:
a movement detection unit, configured to detect displacement information of the projecting device;
an image processing unit, configured to receive an image data frame, modify a position of the image data frame related to a virtual image frame according to the displacement information, and generate a projection frame according to an overlap between the image data frame and the virtual image frame; and
a projection module, configured to project the projection frame on a projection plane.

2. The projection device of claim 1, wherein the image processing unit defines an area of the virtual image frame without overlapping the image data frame as a redundant image area, and sets the image in the redundant image area to a particular image.

3. The projecting device of claim 2, wherein the image processing unit generates the projection frame by combining the particular image of the redundant image area with the image data frame.

4. The projecting device of claim 2, wherein the image processing unit defines an area of the image data frame overlapping the virtual image frame as a modified image data frame, and the image processing unit generates the projection frame by combining the particular image of the redundant image area with the modified image data frame.

5. The projecting device of claim 2, wherein the particular image is a monochrome image or a picture image.

6. The projecting device of claim 1, wherein the image processing unit defines an area of the virtual image frame without overlapping the image data frame as a redundant image area, and the projection module turns off a projection light corresponding to the redundant image area.

7. The projecting device of claim 1, wherein the image processing unit defines an area of the image data frame without overlapping the virtual image frame as a cut image area, and wherein the cut image area is a portion of the image data frame outside the virtual image frame, and not projected onto the projection plane.

8. The projecting device of claim 1, wherein the virtual image frame is an available projection area for the projecting device, and the size of the virtual image frame is larger than or equal to the image data frame.

9. A projection image processing method, for a projecting device, comprising:
detecting displacement information of the projecting device;
modifying a position of the image data frame related to a virtual image frame according to the displacement information;
generating a projection frame according to an overlap between the image data frame and the virtual image frame;
projecting the projection frame on a projection plane.

10. The projection image processing method of claim 9, further comprising:
defining an area of the virtual image frame without overlapping the image data frame as a redundant image area; and
setting the image in the redundant image area to a particular image.

11. The projection image processing method of claim 10, further comprising: generating the projection frame by combining the particular image of the redundant image area with the image data frame.

12. The projection image processing method of claim 10, further comprising:
defining an area of the image data frame overlapping the virtual image frame as a modified image data frame; and
generating the projection frame by combining the particular image of the redundant image area with the modified image data frame.

13. The projection image processing method of claim 10, wherein the particular image is a monochrome image or a picture image.

14. The projection image processing method of claim 9, further comprising:
defining an area of the virtual image frame without overlapping the image data frame as a redundant image area; and
turning off a projection light corresponding to the redundant image area.

15. The projection image processing method of claim 9, further comprising:
defining an area of the image data frame without overlapping the virtual image frame as a cut image area, wherein the cut image area is a portion of the image data frame outside the virtual image frame, and not projected onto the projection plane.

16. The projection image processing method of claim 9, wherein the virtual image frame is an available projection area for the projecting device, and the size of the virtual image frame is larger than or equal to the image data frame.
